(19) United States
(12) Patent Application Publication
(10) Pub. No.: US 2022/0176309 A1
(43) Pub. Date: Jun. 9, 2022

(54) IMPROVEMENTS RELATING TO CARBON DIOXIDE CAPTURE

(71) Applicant: THE PROVOST, FELLOWS, FOUNDATION SCHOLARS, AND THE OTHER MEMBERS OF BOARD, OF THE COLLEGE OF THE HOL, Dublin 2 (IE)

(72) Inventors: Wolfgang SCHMITT, Dublin 2 (IE); Guanghua JIN, Dublin 2 (IE); Sebastien VAESEN, Dublin 2 (IE); Don MACELROY, Dublin 2 (IE); Eleni TSALAPORTA, Dublin 2 (IE)

(21) Appl. No.: 17/427,571

(22) PCT Filed: Jan. 31, 2020
(86) PCT No.: PCT/EP2020/052515

§ 371 Date: Jul. 30, 2021

(30) Foreign Application Priority Data
Feb. 1, 2019 (GB) 1901445.5

(51) Int. Cl. B01D 53/04

(52) U.S. Cl. CPC B01D 53/0438; B01D 2257/504; B01D 53/0446

(57) ABSTRACT

A method is disclosed for separating compressed dry air to provide carbon dioxide and reduced-carbon dioxide compressed dry air. The method comprises providing a source of compressed dry air and admitting compressed dry air into a first chamber containing a carbon dioxide-adsorbent material at a first temperature. The carbon dioxide-adsorbent material adsorbs carbon dioxide from the compressed dry air to form reduced-carbon dioxide compressed dry air, which is allowed to pass out of the first chamber. The first chamber is closed to the source of compressed dry air. Then the carbon dioxide-adsorbent material is heated to a second temperature. This releases carbon dioxide from the carbon dioxide-adsorbent material, which carbon dioxide is removed from the first chamber. The method may be low cost and low energy, and may be easily integrated into existing compressed dry air systems. A carbon dioxide capture unit and a compressed dry air production system for separating compressed dry air to provide carbon dioxide and reduced-carbon dioxide compressed dry air are also described.

### FIELD

The present invention relates to a method of capturing carbon dioxide from air. In particular the invention relates to a method of capturing carbon dioxide from compressed dry air, and also to a carbon dioxide capture unit and a compressed dry air production system comprising such a carbon dioxide capture unit.

### BACKGROUND

Global warming and climate change have attracted the attention of societies, governments, industries and scientists in recent times. A rapid growth in population and the resultant increased energy demands impose extraordinary challenges. Carbon dioxide (CO₂) is the dominant anthropogenic greenhouse gas (82%) and in the last 50 years its atmospheric concentration has increased from 320 ppm in 1965 to almost 400 ppm in 2015. The predictions for the future are pessimistic, with the Intergovernmental Panel on Climate Change estimating that atmospheric CO₂ levels in 2100 will reach 570 ppm, resulting in a 2° C. increase of the mean temperature of the planet which is likely to cause significant disruptions to the Earth's weather and sea levels, resulting in many detrimental effects on the environment. In relation to global warming effects, the estimate for the contribution of CO₂ is approximately 60%.

The reduction of anthropogenic CO₂ could be achieved by targeted actions such as the reduction of the use of fossil fuels by adopting alternative forms of energy, or by developing new carbon (i.e., carbon dioxide) capture sequestration/utilisation technologies. However, a satisfactory replacement of fossil fuels is not expected to be achieved within the next few decades. Therefore carbon capture systems can provide ‘bridge’ technologies for the coming decades, until societies around the globe can implement a sustainable level of ‘green’ energy production using alternative, renewable energy sources. Direct air capture (DAC) technologies have the potential to provide ‘negative CO₂ emissions’ resulting in reduced atmospheric CO₂ concentrations.

Although carbon capture has been on the scientific agenda for many years, attempts to commercialise DAC systems have been scarce, due to unviable CO₂ capture cost estimations and low carbon taxes. Current DAC systems are energy-intensive and require specialised equipment. Consequently the running costs of DAC systems have been high, such that there has been little incentive for the implementation of DAC systems.

### SUMMARY OF THE INVENTION

It is one aim of the present invention, amongst others, to provide a carbon dioxide capture process or system that addresses at least one disadvantage of the prior art, whether identified here or elsewhere, or to provide an alternative to existing carbon dioxide capture processes or systems. For instance it may be an aim of the present invention to provide a carbon dioxide capture process or system with low energetic consumption and low operational costs.

According to aspects of the present invention, there is provided a method, carbon dioxide capture unit, and compressed dry air production system as set forth in the appended claims.

Other features of the invention will be apparent from the dependent claims, and the description which follows.

According to a first aspect of the present invention, there is provided a method of separating compressed dry air to provide carbon dioxide and reduced-carbon dioxide compressed dry air, the method comprising the steps of:

a) providing a source of compressed dry air;

b) admitting compressed dry air into a first chamber containing a carbon dioxide-adsorbent material at a first temperature in order to adsorb carbon dioxide from the compressed dry air onto the carbon dioxide-adsorbent material and to form reduced-carbon dioxide compressed dry air, and allowing the reduced-carbon dioxide compressed dry air to pass out of the first chamber;

c) closing the first chamber to the source of compressed dry air;

d) optionally evacuating the first chamber to remove residual dry air from the first chamber;

e) heating the carbon dioxide-adsorbent material to a second temperature in order to release carbon dioxide from the carbon dioxide-adsorbent material; and

f) removing the carbon dioxide from the first chamber.

The inventors have found that the present invention provides a cost effective low energy carbon capture process because the method and associated carbon dioxide capture unit is integrated into existing compressed dry air systems. Capital expenditure and energy costs are minimised because the main components of existing compressed dry air systems, such as compressors and blowers, are utilised for the capture of carbon dioxide from the compressed dry air, and fewer specialised components are required than if a similar carbon capture system was set up using its own compressors and blowers. Furthermore, the present inventors have found that the conditions in compressed dry air systems give rise to high capture performances under economical conditions due to a low water vapour and increased carbon dioxide pressures. Therefore the present carbon dioxide capture method utilising a compressed dry air source may be particularly efficient and convenient compared to known carbon dioxide capture methods and equipment.

The method according to the first aspect of the present invention may be considered a carbon dioxide capture method.

By compressed dry air we mean dry air that has a pressure which is higher than atmospheric pressure, for example a pressure greater than 1,000 mbar.

Suitably the compressed dry air in the method according to the first aspect has a relative humidity lower than 100%, for example less than 50%, suitably less than 10% or even less than 1%.

Suitably the compressed dry air has a pressure dew point of less than 10° C., for example less than 0° C., suitably less than −10° C. Suitably the compressed dry air has a pressure dew point of at least −90° C., for example at least −80° C., suitably at least −70° C. Suitably the compressed dry air has a pressure dew point of from −90 to 10° C., for example from −80 to 0° C., suitably from −70 to −10° C.

The compressed dry air will typically comprise carbon dioxide that is in gaseous form. Suitably the compressed dry air comprises carbon dioxide in a concentration of at least 100 ppm, for example at least 200 ppm, suitably at least 300 ppm. Suitably the compressed dry air comprises carbon dioxide in a concentration of up to 1,000 ppm, for example up to 700 ppm, suitably up to 500 ppm. Suitably the compressed dry air comprises carbon dioxide in a concentration of from 100 to 1,000 ppm, for example from 200 to 700 ppm, suitably from 300 to 500 ppm.

In the method according to the first aspect of the present invention, step (a) comprises providing a source of compressed dry air. Step (a) suitably comprises producing compressed dry air, for example by compressing and drying air. Processes and equipment for producing compressed dry air would be known to the person skilled in the art. Suitably, producing compressed dry air comprises the steps of:

i) compressing air which contains water vapour to a required pressure to produce compressed air;

ii) producing liquid water from the compressed air and removing the liquid water to produce partially dry compressed air;

iii) filtering the partially dry compressed air to produce filtered partially dry compressed air; and

iv) drying the filtered partially dry compressed air to produce compressed dry air.

The air in step (i) may be ambient air, for example air present in the immediate surroundings of the equipment used to produce the compressed dry air. Such ambient air typically comprises the normal atmospheric concentration of carbon dioxide, for example 400 ppm. The ambient air may be the atmosphere.

Suitably the required pressure in step (i) is greater than atmospheric pressure, suitably greater than 1,000 mbar, suitably significantly greater than 1,000 mbar. Suitably the required pressure in step (i) is at least 2,000 mbar, for example at least 5,000 mbar, suitably at least 9,000 mbar. Suitably the required pressure in step (i) is up to 20,000 mbar, for example up to 15,000 mbar, suitably up to 11,000 mbar. Suitably the required pressure in step (i) is from 2,000 to 20,000 mbar, for example from 5,000 to 15,000 mbar, suitably from 9,000 to 11,000 mbar.

Step (ii) suitably comprises producing liquid water from the compressed air by condensation.

Step (iii) suitably comprises removing components such as dust, oil, and microorganisms from the partially dry compressed air.

Step (iv) may comprise cooling the filtered partially dry compressed air to condense remaining water vapour, contacting the filtered partially dry compressed air with a membrane, contacting the filtered partially dry compressed air with a desiccant, or a combination thereof.

In some embodiments step (a) comprises the sub-steps of:

i) compressing ambient air which contains water vapour and carbon dioxide to greater than 1,000 mbar to produce compressed air;

ii) producing liquid water from the compressed air by condensation and removing the liquid water to produce partially dry compressed air;

iii) filtering dust, oil and microorganisms from the partially dry compressed air to produce filtered partially dry compressed air; and

iv) drying the filtered partially dry compressed air to produce compressed dry air by cooling the filtered partially dry compressed air to condense remaining water vapour, contacting the filtered partially dry compressed air with a membrane, contacting the filtered partially dry compressed air with a desiccant, or a combination thereof.

The present invention may be used with any source of compressed dry air. Compressed dry air is used in many industries and can be considered as the 4^{th} utility after water, electricity, and natural gas. The global energy used to operate compressed air systems was estimated at 80 TWh in 2002. This figure highlights the extent of usage and application (for comparison, the total electricity consumption per year in Europe is about 3,000 TWh). Globally, an enormous amount of energy is already applied to power these systems and flow the air. The capture of carbon dioxide in these systems will reduce their net emissions and significantly reduce their negative ecological impact. Moreover, the present invention produces high purity carbon dioxide which can be used in various applications as described further herein. A ready supply of high purity carbon dioxide may facilitate the development and/or commercialisation of new and/or existing technologies.

In the method according to the first aspect of the present invention, step (b) comprises admitting compressed dry air into a first chamber containing a carbon dioxide-adsorbent material. The carbon dioxide-adsorbent material is at a first temperature. Carbon dioxide is adsorbed from the compressed dry air onto the carbon dioxide-adsorbent material when the compressed dry air is admitted into the first chamber, thereby forming reduced-carbon dioxide compressed dry air. The reduced-carbon dioxide compressed dry air is allowed to pass out of the first chamber.

The source of compressed dry air is suitably in fluid communication with the first chamber.

The first chamber is suitably a pressurisable chamber, by which we mean a chamber able to withstand a pressure higher than atmospheric pressure. Suitably the first chamber is a pressurisable chamber able to withstand the pressure of the compressed dry air. Suitably the first chamber is able to withstand pressures greater than 1,000 mbar, suitably significantly greater than 1,000 mbar. Suitably the first chamber is able to withstand pressures of at least 2,000 mbar, for example at least 5,000 mbar, suitably at least 9,000 mbar. Suitably the first chamber is able to withstand pressures of up to 10,000 mbar, for example up to 15,000 mbar, suitably up to 20,000 mbar or up to 25,000 mbar.

The first chamber suitably comprises a first gas inlet through which compressed dry air is admitted from the source of compressed dry air into the first chamber, and a first gas outlet through which reduced-carbon dioxide compressed dry air is permitted to pass out of the first chamber. The first chamber may comprise more than one first gas outlet. Therefore compressed dry air may enter the first chamber through a gas inlet, pass through the first chamber, become reduced-carbon dioxide compressed dry air, and leave the first chamber through a gas outlet. The first chamber is suitably enclosed apart from gas inlets and gas outlets such that ambient air cannot enter the first chamber. The wall enclosing the first chamber may be formed from a material which is impermeable to gas, for example a metallic material, suitably steel.

The first chamber may be of any suitable size and contain any suitable amount of carbon dioxide-adsorbent material. The person skilled in the art would be able to determine a suitable size for the first chamber and a suitable amount of carbon dioxide-adsorbent material based on the operating conditions such as the desired flow rate of the compressed dry air and/or the carbon dioxide adsorbing capacity of the carbon dioxide-adsorbent material.

The carbon dioxide-adsorbent material may comprise any material which is able to adsorb carbon dioxide. Such materials would be known to the person skilled in the art. Suitably the carbon dioxide-adsorbent material is selective for carbon dioxide. By this we mean that the carbon dioxide-adsorbent material preferentially adsorbs carbon dioxide over other gases in the compressed dry air. Suitably, the carbon dioxide-adsorbent material does not adsorb other gases present in the compressed dry air, such as oxygen or nitrogen. Suitably the carbon dioxide-adsorbent material is porous, for example macroporous, mesoporous, and/or microporous. Suitably the carbon dioxide-adsorbent material is stable under the conditions, for example the temperatures and pressures, to which the carbon dioxide-adsorbent material is subjected during the method according to the first aspect. Suitable carbon dioxide-adsorbent materials include amine-functionalised silica adsorbents, functionalised porous aluminosilicates, clays, mesoporous carbons and metal-organic frameworks. A suitable example of an amine-functionalised silica adsorbent is APTES-SBA-15, where SBA-15 is a mesoporous ordered silica and APTES is (3-aminopropyl)triethoxysilane. Suitable examples of metal-organic frameworks include MOF-74 such as Mg-MOF-74 and Ni-MOF-74, and SIFSIX-based materials such as SIFSIX-3-Cu and SIFSIX-3-Ni.

By macroporous, we mean a material having pores of a size greater than 50 nm (i.e. macropores). By mesoporous, we mean a material having pores of a size from 2 nm to 50 nm (i.e. mesopores). By microporous, we mean a material having pores of a size less than 2 nm (i.e., micropores).

Suitably the carbon dioxide-adsorbent material is arranged in the first chamber such that the compressed dry air admitted into the first chamber flows through the carbon dioxide-adsorbent material. The carbon dioxide-adsorbent material may be arranged as an adsorbent bed. The adsorbent bed may comprise packed pellets of the carbon dioxide-adsorbent material, a monolith of the carbon dioxide-adsorbent material, and/or the carbon dioxide-adsorbent material supported on fibres, for example nanofibres. The carbon dioxide-adsorbent material may be in the form of microparticles.

The compressed dry air suitably flows through the first chamber such that the compressed dry air is in close contact with the carbon dioxide-adsorbent material. The flow rate of the compressed dry air through the first chamber may be adjusted to achieve a desired adsorption rate of carbon dioxide to the carbon dioxide-adsorbent material.

In embodiments wherein the first chamber contains an adsorbent bed comprising packed pellets of a macroporous and/or microporous carbon dioxide-adsorbent material which is formed of microparticles, the rates of adsorption within the packed pellets may be governed by a combination of micropore and macropore diffusion and surface reaction, and the optimal air velocity uₒₚₜ for step (b) may be determined using the following equation

$${u}_{opt} = \frac{1}{{ɛ}_{B}} \sqrt{\frac{{ɛ}_{B} {D}_{m}}{{τ}_{B}} [ \frac{1 - {ɛ}_{B}}{\frac{1}{{ɛ}_{M} {K}_{H}} = ( \frac{{R}_{μ}^{2}}{15 {D}_{μ}} + \frac{1}{{k}_{Ads} {c}_{s}^{o}} ) + \frac{{R}_{p}}{3 {K}_{C}}} ]}$$

$$where$$

$$\frac{1}{{K}_{C}} ( \frac{{R}_{p}}{5 {ɛ}_{M}} \frac{1}{{D}_{M}} + \frac{1}{{k}_{cf}^{( B )}} )$$

The parameters are as follows:

ε_{B}, ε_{M} are the bed voidage and the macropore voidage of the pellets, respectively.

τ_{B} is the tortuosity of the flow channels through the packed pellets.

Dₘ is the molecular diffusivity of the carbon dioxide in air at the given pressure and temperature.

K_{H} is the partition coefficient for the carbon dioxide between the gas in the macropores and the gas in the micropores within the microparticles of the adsorbent material.

R_{μ}, Rₚ are the microparticle radius and the pellet radius, respectively.

D_{μ} is the diffusivity of the carbon dioxide within the micropores of the pellets.

k_{Ads} is the forward reaction rate constant for attachment of the carbon dioxide to reactive adsorption sites in the adsorbent material.

cₛ^{o} is the bare surface reactive site concentration.

D_{M} is the diffusivity of the carbon dioxide within the macropores of the pellets.

k_{cf}^{(B)} is the fluid film mass transfer coefficient surrounding the pellets.

The different variables could be readily determined by a skilled person by geometric characterisation of the adsorbent pellets, by measuring CO₂/N₂ breakthrough curves on adsorbent pellets, by using empirical equations well known in chemical engineering and by using mathematical tools such as partial differential equations models and parameters minimisation.

The first temperature of the carbon dioxide-adsorbent material is low enough that carbon dioxide will adsorb to the carbon dioxide-adsorbent material at the pressure in the first chamber in step (b). Suitably the first temperature is ambient, for example room temperature. Suitably the first temperature is at least −10° C., for example at least 0° C., suitably at least 5° C., suitably at least 15° C. Suitably the first temperature is up to 50° C., for example up to 35° C., suitably up to 25° C. Suitably the first temperature is from −10 to 50° C., for example from 5 to 35° C., suitably from 15 to 25° C.

Suitably the pressure in the first chamber in at least a part of step (b) is greater than 1,000 mbar, suitably significantly greater than 1,000 mbar. Suitably the pressure in the first chamber in at least a part of step (b) is at least 2,000 mbar, for example at least 5,000 mbar, suitably at least 9,000 mbar. Suitably the pressure in the first chamber in at least a part of step (b) is up to 20,000 mbar, for example up to 15,000 mbar, suitably up to 11,000 mbar. Suitably the pressure in the first chamber in at least a part of step (b) is from 2,000 to 20,000 mbar, for example from 5,000 to 15,000 mbar, suitably from 9,000 to 11,000 mbar.

Step (b) may be carried out until the carbon dioxide-adsorbent material has the desired level of saturation with carbon dioxide. Step (b) is suitably carried out until the carbon dioxide-adsorbent material is at least 70%, for example at least 80%, suitably at least 90% saturated with carbon dioxide. Suitably step (b) is carried out until the carbon dioxide-adsorbent material is fully saturated with carbon dioxide.

The reduced-carbon dioxide compressed dry air which is allowed to pass out of the first chamber comprises a lower concentration of carbon dioxide than the compressed dry air which is admitted into the first chamber.

The reduced-carbon dioxide compressed dry air may be used in any suitable application for which compressed dry air is normally used. Such applications would be known to the skilled person. Examples of suitable applications for the reduced-carbon dioxide compressed dry air include spraying, operating air controlled tools, cooling, handling, cleaning, pneumatics, refrigeration, sandblasting, injection moulding, and packaging and transportation of foods and beverages.

In the method according to the first aspect of the present invention, step (c) comprises closing the first chamber to the source of compressed dry air. As a result, the source of compressed dry air is not in fluid communication with the first chamber and compressed dry air is not admitted into the first chamber. The compressed dry air may be diverted to flow through a different path, i.e., a path which does not comprise the first chamber. In some embodiments the compressed dry air may be diverted to a second chamber in order to carry out another method according to this first aspect using the second chamber.

Step (c) may also comprise venting the first chamber, for example to the atmosphere, in order to decrease the pressure in the first chamber, for example to atmospheric pressure.

The temperature of the carbon dioxide-adsorbent material in step (c) is suitably the first temperature.

The method according to the first aspect of the present invention suitably comprises the further step of
d) evacuating the first chamber to remove residual dry air from the first chamber.

The residual dry air is the air remaining in the first chamber after step (c) has been carried out. The residual dry air which is removed from the first chamber in step (d) is suitably released to the atmosphere. Step (d) advantageously increases the purity of carbon dioxide recovered in subsequent steps.

Step (d) suitably comprises applying a vacuum to the first chamber. Suitably the pressure in the first chamber in at least a part of step (d) is less than 20 mbar, for example less than 10 mbar, suitably less than 5 mbar.

The temperature of the carbon dioxide-adsorbent material in step (d) is suitably the first temperature.

In the method according to the first aspect of the present invention, step (e) comprises heating the carbon dioxide-adsorbent material to a second temperature in order to release carbon dioxide from the carbon dioxide-adsorbent material. The carbon dioxide released in this way is suitably in gaseous form.

The second temperature of the carbon dioxide-adsorbent material is suitably high enough that carbon dioxide will desorb from the carbon dioxide-adsorbent material at the pressure in the first chamber in step (e). Suitably the second temperature is higher than the first temperature. Suitably the second temperature is at least 50° C., for example at least 60° C., suitably at least 70° C. Suitably the second temperature is up to 200° C., for example up to 150° C., suitably up to 100° C. Suitably the second temperature is from 50 to 200° C., for example from 60 to 150° C., suitably from 70 to 100° C. Suitably the second temperature is selected so as to not degrade the carbon dioxide-adsorbent material.

Suitably the pressure in the first chamber in at least a part of step (e) is less than 20 mbar, for example less than 10 mbar, suitably less than 5 mbar.

Step (e) suitably comprises sealing the first chamber, for example at the beginning of step (e), such that heating the carbon dioxide-adsorbent material to the second temperature increases the pressure of carbon dioxide in the first chamber. When the first chamber is sealed, no gas can pass in or out of the first chamber.

Step (e) may comprise heating the carbon dioxide-adsorbent material using waste operational heat, green energy, or carbon-emitting energy, if necessary. The waste operational heat may be obtained from the source of compressed dry air. By green energy we mean energy which is generated without burning fossil fuels, for example solar energy, wind energy, or geothermal energy. By carbon-emitting energy we mean energy which is generated by burning fossil fuels, such as coal, oil or natural gas.

Suitably no other gas (other than the carbon dioxide already present) contacts the carbon dioxide-adsorbent material in step (e). Suitably no other gas contacts the carbon dioxide-adsorbent material in step (e) or step (f). Suitably no gas except the carbon dioxide already present is supplied to or contacts the carbon dioxide-adsorbent material in step (e) or step (f). Therefore step (e) and step (f) suitably do not involve using a stream of gas (for example N₂) flowing onto the carbon dioxide-adsorbent material to release the carbon dioxide and regenerate the carbon dioxide-adsorbent material for subsequently adsorbing further carbon dioxide. Therefore suitably no diluent gas is present in the carbon dioxide produced by the method of this first aspect. The carbon dioxide produced by this method may therefore not require further separation or purification before use.

Step (e) may involve using a heat transfer fluid (such as liquid water, steam, glycol solution or heated N₂ gas) to heat the carbon dioxide-adsorbent material and release carbon dioxide from the carbon dioxide-adsorbent material. In such embodiments there is no direct contact between the heat transfer fluid and the carbon dioxide-adsorbent material, i.e. there is no contact between the inside of the first chamber and the heat transfer fluid. Such heating may be referred to as indirect heating and provides no dilution of the released carbon dioxide by the heat transfer fluid. Therefore the method of this first aspect suitably provides undiluted and suitably high purity carbon dioxide.

In the method according to the first aspect of the present invention, step (f) comprises removing the carbon dioxide from the first chamber. Suitably step (f) comprises removing the gaseous carbon dioxide from the first chamber which was released from the carbon dioxide-adsorbent material during step (e).

In embodiments wherein step (e) comprises sealing the first chamber, step (f) suitably comprises opening the first chamber so that carbon dioxide is allowed to pass out of the first chamber. Suitably step (f) does not comprise opening the first chamber so that a gas is admitted into the first chamber.

Step (f) suitably comprises applying a vacuum to the first chamber. Suitably the pressure in the first chamber in at least a part of step (e) is less than 20 mbar, for example less than 10 mbar, suitably less than 5 mbar.

Step (f) is suitably carried out until the desired amount of the carbon dioxide is removed. The amount of carbon dioxide removed can be selected by the skilled person to ensure economical capture of the carbon dioxide. Suitably step (f) is carried out until at least 50%, for example at least 70%, suitably at least 90% of the carbon dioxide is removed based on the total amount of carbon dioxide present in the first chamber at the beginning of step (f), which is suitably the same as the total amount of carbon dioxide present in the first chamber during step (e). The total amount of carbon dioxide in the first chamber includes gaseous carbon dioxide and carbon dioxide that is adsorbed to the carbon dioxide-adsorbent material.

The amount of carbon dioxide removed from the first chamber can be readily determined by a skilled person, for example by measuring the concentration and the flow of carbon dioxide exiting the first chamber during step (f) or by measuring the residual carbon dioxide concentration in the reduced-carbon dioxide compressed dry air at the first gas outlet during the next step (b) carried out in the first chamber following step (f).

Step (f) may comprise directing the carbon dioxide removed from the first chamber to a carbon dioxide storage vessel. Step (f) may comprise compressing the carbon dioxide removed from the first chamber before directing the carbon dioxide to the carbon dioxide storage vessel. Directing carbon dioxide from the first chamber to a carbon dioxide storage vessel may alternatively be defined as recovering the carbon dioxide.

The carbon dioxide removed from the first chamber in step (f) suitably has a purity of at least 90% by volume, for example at least 95% per volume, suitably at least 99% by volume.

The carbon dioxide which is removed from the first chamber may be used in any suitable application for which carbon dioxide is normally used. Such applications would be known to the skilled person. Examples of suitable applications include medical use of the carbon dioxide (for example, mixed with pure oxygen to stimulate breathing), and use of the carbon dioxide in agriculture (for example, in greenhouses), in food (for example, as a refrigerant), in beverages (for example, for carbonating drinks), in water treatment (for example, for controlling pH), in welding processes (for example, as a shield gas), and in the chemical industry (for example, as a chemical feedstock). Carbon dioxide may also be used for conversion into fuels.

In alternative embodiments, the carbon dioxide which is removed from the first chamber may be sequestered. By sequestered, we mean that the carbon dioxide is stored for a long period of time such that it is not released to the atmosphere. Suitably sequestered carbon dioxide is stored for at least 10 years, for example at least 50 years, suitably at least 100 years. Sequestered carbon dioxide may be stored on geological timescales, for example up to 10,000 years.

The temperature of the carbon dioxide-adsorbent material in step (f) is suitably the second temperature.

In the method according to the first aspect of the present invention, the steps of the method are suitably carried out in the order step (a), followed by step (b), followed by step (c), followed by step (d) when present, followed by step (e), followed by step (f).

The method according to the first aspect of the present invention suitably comprises the further step of:
g) cooling the carbon dioxide-adsorbent material to the first temperature.

Step (g) suitably comprises sealing the first chamber, for example at the beginning of step (g). This prevents contaminant gas from being drawn into the first chamber as the gas within the first chamber cools and contracts.

Suitably the pressure in the first chamber in at least a part of step (g) is less than 20 mbar, for example less than 10 mbar, suitably less than 5 mbar.

Step (g) may comprise allowing the carbon dioxide-adsorbent material to cool passively. By passive cooling, we mean that the carbon dioxide-adsorbent material is cooled without using energy. This advantageously lowers the cost of carrying out step (g). The carbon dioxide-adsorbent material may be cooled passively through heat loss to the ambient environment.

Alternatively step (g) may comprise actively cooling the carbon dioxide-adsorbent material. This has the advantage of having greater control over the rate of cooling of the carbon dioxide-adsorbent material, for example cooling the carbon dioxide-adsorbent material more quickly. Suitably the carbon dioxide-adsorbent material is actively cooled by allowing a refrigerant or a fluid having a lower temperature than the first temperature to contact the outside of the first chamber. Suitably the fluid is a liquid or a gas.

Step (g) suitably follows step (f.

The method may further comprise repeating step (b) following step (g). Suitably step (b) is carried out once the carbon dioxide-adsorbent material is at the first temperature. In any embodiment herein where step (g) is followed by step (b), step (b) may alternatively be carried out at the same time as step (g) so that the carbon dioxide-adsorbent material is cooled by contact with the compressed dry air. This has the advantage that the carbon dioxide-adsorbent material may be cooled more quickly without the use of an external active cooling system. In such embodiments step (b) may begin before, after, or at the same time as the beginning of step (g). In such embodiments step (g) suitably does not comprise sealing the first chamber.

Suitably the method comprises repeating each of step (b), step (c), step (d) when present, step (e), and step (f) following step (g), where step (f) may again be followed by step (g). Therefore, following step (a), one or more cycles comprising step (b), step (c), step (d) when present, step (e), step (f, and step (g) when present, can be carried out. Suitably step (b), step (c), step (d) when present, step (e), step (f), and step (g) when present, are repeated at least once, for example at least twice.

Carrying out multiple cycles of carbon capture continuously has the advantage that the method can be carried out more efficiently and at lower cost. This is possible because the carbon dioxide-adsorbent material does not need to be removed from the first chamber in order to regenerate the carbon dioxide-adsorbent material by removing carbon dioxide adsorbed thereto. Therefore the first chamber can continuously be in use, and the productivity and efficiency of the first chamber can be maximised.

Suitably, the duration of the steps may be selected by a skilled person in order to optimise the performance of the method. For example, step (b) may be carried out for the same period of time as step (c), step (d) when present, step (e), step (f, and step (g) when present, combined. Therefore the total length of time used to carry out step (c), step (d) when present, step (e), step (f, and step (g) when present, may be the same as the length of time used to carry out step (b).

In some embodiments the method according to the first aspect comprises the steps of:

a) providing a source of compressed dry air, the compressed dry air having a pressure of at least 1,000 mbar, a carbon dioxide concentration of at least 100 ppm, and a pressure dew point of less than 10° C.;

b) admitting the compressed dry air into a first chamber containing a carbon dioxide-adsorbent material at a first temperature in order to adsorb carbon dioxide from the compressed dry air onto the carbon dioxide-adsorbent material and to form reduced-carbon dioxide compressed dry air, and allowing the reduced-carbon dioxide compressed dry air to pass out of the first chamber, wherein the reduced-carbon dioxide compressed dry air comprises a lower concentration of carbon dioxide than the compressed dry air;

c) closing the first chamber to the source of compressed dry air once the carbon dioxide-adsorbent material is substantially fully saturated with carbon dioxide and venting the first chamber in order to decrease the pressure in the first chamber to atmospheric pressure, wherein the carbon dioxide-adsorbent material is at the first temperature;

d) optionally applying a vacuum to the first chamber in order to remove residual dry air from the first chamber, wherein the pressure in the first chamber in at least a part of step (d) is less than 20 mbar, and the carbon dioxide-adsorbent material is at the first temperature;

e) sealing the first chamber and heating the carbon dioxide-adsorbent material to a second temperature in order to release carbon dioxide from the carbon dioxide-adsorbent material; and

f) applying a vacuum to the first chamber in order to remove at least 50% of the carbon dioxide from the first chamber based on the total amount of carbon dioxide in the first chamber at the beginning of step (f), and directing the carbon dioxide removed from the first chamber to a carbon dioxide storage vessel, wherein the pressure in the first chamber in at least a part of step (f) is less than 20 mbar, the purity of the carbon dioxide removed from the first chamber is at least 90% by volume, and the carbon dioxide-adsorbent material is at the second temperature; and optionally

g) cooling the carbon dioxide-adsorbent material to the first temperature;

wherein the first temperature is from −10 to 50° C., the second temperature is at least 50° C., and the carbon dioxide-adsorbent material is a porous material which preferentially adsorbs carbon dioxide over other gases present in compressed dry air.

In such embodiments, the compressed dry air in step a) suitably has a pressure of at least 5,000 mbar, a carbon dioxide concentration of at least 200 ppm, and a pressure dew point of less than 0° C. Suitably the compressed dry air in step a) has a pressure of at least 9,000 mbar, a carbon dioxide concentration of at least 300 ppm, and a pressure dew point of less than −10° C.

In such embodiments, the concentration of carbon dioxide in the reduced-carbon dioxide compressed dry air in step b) is less than 200 ppm, suitably less than 100 ppm.

In such embodiments, the pressure in the first chamber in at least a part of step (d) when present is suitably less than 10 mbar, suitably less than 5 mbar.

In such embodiments, step f) involves removing at least 50% of the carbon dioxide from the first chamber based on the total amount of carbon dioxide in the first chamber at the beginning of step (f, suitably at least 70%.

In such embodiments, the pressure in the first chamber in at least a part of step (f) is suitably less than 10 mbar, suitably less than 5 mbar.

In such embodiments, the purity of the carbon dioxide removed from the first chamber is suitably at least 95% by volume, suitably at least 99%.

In such embodiments, the pressure in the first chamber in at least a part of step (g) is suitably less than 10 mbar, suitably less than 5 mbar.

In such embodiments, the method involves optionally repeating step (b), step (c), step (d) when present, step (e), step (f, and step (g) when present, at least once.

In the method according to the first aspect of the present invention, step (b), step (c), step (d) when present, step (e), step (f, or step (g) when present, may be carried out in more than one chamber in parallel. By this we mean that there may be provided the first chamber and at least one further chamber in which the same step is carried out simultaneously. This has the advantage that the throughput of the method is not limited by the size of the first chamber, because the method can be carried out in more than one chamber simultaneously. Therefore, even if the first chamber is only available in a small size, the method can be carried out on any desired scale.

In the method according to the first aspect of the present invention, step (b) may be carried out in the first chamber while step (c), step (d) when present, step (e), step (f), or step (g) when present, are carried out simultaneously in a second chamber containing a carbon dioxide-adsorbent material. Alternatively, step (b) may be carried out in a second chamber containing a carbon dioxide-adsorbent material while step (c), step (d) when present, step (e), step (f, or step (g) when present, are carried out simultaneously in the first chamber. The suitable features of the second chamber are as described above in relation to the first chamber. Suitably the first chamber and the second chamber are substantially identical.

In embodiments wherein step (b) is carried out in the first chamber and step (c), step (d) when present, step (e), step (f, or step (g) when present, are carried out simultaneously in the second chamber, or vice versa, step (b) is suitably carried out for the same period of time as step (c), step (d) when present, step (e), step (f), and step (g) when present, combined. Step (b) suitably finishes in the first chamber at the same time as step (b) begins in the second chamber, or vice versa. Therefore step (b) may be carried out continuously across multiple cycles of step (b), step (c), step (d) when present, step (e), step (f, and step (g) when present. Suitably the source of compressed dry air is in continuous fluid communication with one of the first chamber and the second chamber across multiple cycles of step (b), step (c), step (d) when present, step (e), step (f), and step (g) when present. Therefore, the source of compressed dry air is suitably switched between the first and second chambers as step (b) finishes in one of the chambers and step (f, or step (g) when present, finishes in the other of the chambers.

The method of the first aspect may be carried out in a plurality of chambers containing a carbon dioxide-adsorbent material, wherein the chambers are in sequence or in parallel. The plurality of chambers may comprise two, three, four, or more than four chambers. Suitably the compressed dry air is continuously supplied into at least one of the plurality of chambers.

Using a first chamber and a second chamber or a plurality of chambers as described above advantageously allows for continuous capture of carbon dioxide and the continuous production of reduced-carbon dioxide compressed dry air. Therefore the supply of carbon dioxide and/or reduced-carbon dioxide compressed dry air can be uninterrupted by moving between the capture phase (i.e., step (b)) and the regeneration phase (i.e., step (c), step (d) when present, step (e), step (f), and step (g) when present), thereby allowing for higher efficiency and lower costs.

In some embodiments the method according to the first aspect comprises the steps of:

a) providing a source of compressed dry air;

b1) admitting compressed dry air into a first chamber containing a carbon dioxide-adsorbent material at a first temperature in order to adsorb carbon dioxide from the compressed dry air onto the carbon dioxide-adsorbent material and to form reduced-carbon dioxide compressed dry air, and allowing the reduced-carbon dioxide compressed dry air to pass out of the first chamber;

c1) closing the first chamber to the source of compressed dry air;

d1) evacuating the first chamber to remove residual dry air from the first chamber;

e1) heating the carbon dioxide-adsorbent material in the first chamber to a second temperature in order to release carbon dioxide from the carbon dioxide-adsorbent material; and

f1) removing the carbon dioxide from the first chamber;

g1) optionally cooling the carbon dioxide-adsorbent material in the first chamber to the first temperature;

b2) admitting compressed dry air into a second chamber containing a carbon dioxide-adsorbent material at a first temperature in order to adsorb carbon dioxide from the compressed dry air onto the carbon dioxide-adsorbent material and to form reduced-carbon dioxide compressed dry air, and allowing the reduced-carbon dioxide compressed dry air to pass out of the second chamber;

c2) closing the second chamber to the source of compressed dry air;

d2) evacuating the second chamber to remove residual dry air from the second chamber;

e2) heating the carbon dioxide-adsorbent material in the second chamber to a second temperature in order to release carbon dioxide from the carbon dioxide-adsorbent material; and

f2) removing the carbon dioxide from the second chamber; and optionally

g2) cooling the carbon dioxide-adsorbent material in the second chamber to the first temperature;

wherein step (b1) and step (c2), step (d2), step (e2), step (f2), or step (g2) when present, are carried out simultaneously, and step (b2) and step (c1), step (d1), step (e1), and step (f1), and step (g1) when present, are carried out simultaneously.

According to a second aspect of the present invention, there is provided a carbon dioxide capture unit for removing carbon dioxide from a source of compressed dry air, the carbon dioxide capture unit comprising:

at least one chamber comprising a carbon dioxide-adsorbent material, a gas inlet, and a gas outlet;

a heater for heating the carbon dioxide-adsorbent material;

an input valve in fluid communication with the gas inlet for connection of the gas inlet to a source of compressed dry air; and

at least one output valve in fluid communication with the gas outlet for connection of the gas outlet to a reduced-carbon dioxide compressed dry air output and a carbon dioxide output.

The suitable features and advantages of the source of compressed dry air, the at least one chamber, the carbon dioxide-adsorbent material, the gas inlet and the gas outlet of this second aspect are as described above in relation to the source of compressed dry air, the first chamber, the carbon dioxide-adsorbent material, the first gas inlet and the first gas outlet, respectively, of the first aspect.

The heater is suitably able to heat the carbon dioxide-adsorbent material to a second temperature as described above in relation to the first aspect. The heater may heat the carbon dioxide-adsorbent material directly, for example by direct contact with the carbon dioxide-adsorbent material, or the heater may heat the carbon dioxide-adsorbent material indirectly, for example by heating the at least one chamber. Suitably the heater is contained within the at least one chamber, for example as part of an adsorbent bed, or the heater may at least partially covers an outer surface of the at least one chamber. The heater may comprise a heating element that may generate heat by passing an electric current through the heating element. The electric current may be generated by green energy. The heater may comprise a conduit for conveying a heated fluid, for example a liquid or a gas, suitably water. The conduit suitably conveys fluid which is heated by waste operational heat, for example waste operational heat generated by the source of compressed dry air.

The carbon dioxide capture unit according to the second aspect of the present invention may comprise a cooler for cooling the carbon dioxide-adsorbent material. The cooler suitably comprises a conduit for conveying a fluid, for example a liquid or a gas, suitably water.

The carbon dioxide capture unit according to the second aspect of the present invention suitably comprises a temperature sensor for determining the temperature of the carbon dioxide-adsorbent material and/or the temperature of the at least one chamber.

The input valve suitably has a first position and a second position. The first position of the input valve allows gas to pass through the input valve to the gas inlet. The first position of the input valve may be additionally defined as the open position of the input valve. Suitably the first position of the input valve does not allow gas to pass from the gas inlet through the input valve. The second position of the input valve does not allow gas to pass through the input valve. The second position of the input valve may additionally be defined as the closed position of the input valve. Suitably the input valve is a two-port valve.

The at least one output valve suitably has a first position and a second position. The first position of the at least one output valve allows gas to pass from the gas outlet through the at least one output valve. The first position of the at least one output valve may be additionally defined as the open position of the at least one output valve. Suitably the first position of the at least one output valve does not allow gas to pass through the at least one output valve to the gas outlet and into the first chamber. The second position of the at least one output valve does not allow gas to pass through the at least one output valve. The second position of the at least one output valve may additionally be defined as the closed position of the at least one output valve. Suitably the at least one output valve is a two-port valve.

The at least one output valve may comprise one output valve for connection of the gas outlet to the reduced-carbon dioxide compressed dry air output and for connection of the gas outlet to the carbon dioxide output. Alternatively the at least one output valve may comprise a first output valve for connection of the gas outlet to the reduced-carbon dioxide compressed dry air output and a second output valve for connection of the gas outlet to the carbon dioxide output. In embodiments wherein the at least one chamber comprises more than one gas outlet, the at least one output valve may comprise a first output valve for connection of a first gas outlet to the reduced-carbon dioxide compressed dry air output and a second output valve for connection of a second gas outlet to the carbon dioxide output.

The carbon dioxide capture unit according to the second aspect of the present invention suitably comprises a vacuum pump. The vacuum pump is suitably for reducing the pressure in the at least one chamber and/or drawing gas from the at least one chamber. Suitably gas is able to flow through the vacuum pump. The vacuum pump is suitably in fluid communication with the at least one output valve, for example such that when the at least one output valve is in the first position, the vacuum pump is in fluid communication with the gas outlet of the at least one chamber. Suitably the vacuum pump is able to reduce the pressure in the at least one chamber to less than 20 mbar, for example less than 10 mbar, suitably less than 5 mbar.

The carbon dioxide capture unit according to the second aspect of the present invention suitably comprises a pressure sensor for determining the pressure in the at least one chamber and/or the pressure in the vacuum pump.

The carbon dioxide capture unit according to the second aspect of the present invention suitably comprises a carbon dioxide output. The carbon dioxide output suitably comprises a carbon dioxide storage vessel. The carbon dioxide storage vessel is suitably able to store carbon dioxide gas under high pressure, for example a pressure higher than atmospheric pressure, suitably a pressure greater than 1,000 mbar. The carbon dioxide output may comprise a carbon dioxide compressor for compressing carbon dioxide gas to a high pressure, suitably a pressure greater than 1,000 mbar. The compressor is suitably in fluid communication with the carbon dioxide storage vessel. The carbon dioxide output is suitably in fluid communication with the at least one output valve, for example the second output valve. The carbon dioxide output may be in fluid communication with the vacuum pump.

The carbon dioxide capture unit may comprise a vacuum pump valve in fluid communication with the vacuum pump. The vacuum pump valve suitably has a first position which allows gas to pass though the vacuum pump to the atmosphere. Suitably the first position of the vacuum pump valve does not allow gas to pass through the vacuum pump valve to the vacuum pump. The vacuum pump valve suitably has a second position of the vacuum pump valve does not allow gas to pass through the vacuum pump valve.

The vacuum pump valve may be in fluid communication with the carbon dioxide output, for example such that the carbon dioxide output is in fluid communication with the vacuum pump through the vacuum pump valve. The vacuum pump valve suitably has a third position which allows gas to pass though the vacuum pump to the carbon dioxide output. Suitably the third position of the vacuum pump valve does not allow gas to pass through the vacuum pump valve to the vacuum pump. Suitably the vacuum pump valve is a three-port valve.

In embodiments wherein the vacuum pump valve has a first position and a third position as defined above, the first position and the third position of the vacuum pump valve suitably do not allow gas to pass through the vacuum pump valve from the carbon dioxide output to the atmosphere or from the atmosphere to the carbon dioxide output. Suitably the carbon dioxide output is not in fluid communication with the atmosphere.

The carbon dioxide capture unit according to the second aspect of the present invention may comprise a vent valve for venting the at least one chamber to the atmosphere. Suitably the vent valve is in fluid communication with the gas outlet of the at least one chamber. Suitably the vent valve is not in fluid communication with the vacuum pump. The vent valve suitably has a first position and second position. The first position of the vent valve allows gas to pass from the gas outlet through the vent valve. The first position of the vent valve may be additionally defined as the open position of the vent valve. Suitably the first position of the vent valve does not allow gas to pass through the vent valve to the gas outlet. The second position of the vent valve does not allow gas to pass through the vent valve. The second position of the vent valve may additionally be defined as the closed position of the vent valve. Suitably the vent valve is a two-port valve.

In some embodiments the carbon dioxide capture unit according to the second aspect comprises:

a carbon dioxide output comprising a carbon dioxide storage vessel able to store carbon dioxide under a pressure of greater than 1,000 mbar;

at least one chamber comprising a carbon dioxide-adsorbent material, a gas inlet, and a gas outlet, wherein the at least one chamber is a pressurisable chamber able to withstand pressures of greater than 1,000 mbar, suitably significantly greater than 1,000 mbar, and the carbon dioxide-adsorbent material is a porous material which preferentially adsorbs carbon dioxide over other gases present in compressed dry air;

a heater for heating the carbon dioxide-adsorbent material, wherein the heater is able to heat the carbon dioxide adsorbent material to a second temperature, wherein the second temperature is at least 50° C.;

a two-port input valve in fluid communication with the gas inlet for connection of the gas inlet to a source of compressed dry air;

a two-port first output valve in fluid communication with the gas outlet for connection of the gas outlet to a reduced-carbon dioxide compressed dry air output;

a two-port second output valve in fluid communication with the gas outlet for connection of the gas outlet to the carbon dioxide output;

a two-port vent valve for venting the at least one chamber to the atmosphere, wherein the vent valve is in fluid communication with the gas outlet of the at least one chamber;

a vacuum pump for reducing the pressure in the at least one chamber and/or for drawing gas from the at least one chamber, wherein the vacuum pump is in fluid communication with the second output valve, and the vacuum pump is able to reduce the pressure in the at least one chamber to less than 20 mbar; and

a three-port vacuum pump valve in fluid communication with the vacuum pump, the atmosphere, and the carbon dioxide output.

Suitably the at least one chamber comprises a plurality of chambers. In such embodiments the carbon dioxide capture unit suitably comprises the input valve, the at least one output valve, the heater, the cooler, the temperature sensor, the pressure sensor and/or the vent valve for each chamber.

Suitably the at least one chamber comprises a first chamber and a second chamber. The carbon dioxide capture unit suitably comprises one of the input valve and the output valve for each of the first chamber and the second chamber. Suitably the first chamber and the second chamber suitably are not in fluid communication with the same input valve. Therefore the input valve in fluid communication with the gas inlet of the first chamber is suitably not the same as the input valve in fluid communication with the gas inlet of the second chamber. Suitably the first chamber and the second chamber suitably are not in fluid communication with the same output valve. Therefore the output valve in fluid communication with the gas outlet of the first chamber is suitably not the same as the output valve in fluid communication with the gas outlet of the second chamber.

Suitably the first chamber and the second chamber are substantially identical.

The first chamber and the second chamber have the same advantages described above in relation to the first aspect.

Suitably the carbon dioxide capture unit comprises one of the heater, the cooler, and/or the vent valve for each of the first chamber and the second chamber.

In some embodiments the carbon dioxide capture unit according to the second aspect comprises:

a carbon dioxide output comprising a carbon dioxide compressor and a carbon dioxide storage vessel able to store carbon dioxide under a pressure of greater than 1,000 mbar, suitably significantly greater than 1,000 mbar;

a first chamber comprising a carbon dioxide-adsorbent material, a gas inlet, and a gas outlet, wherein the first chamber is a pressurisable chamber able to withstand pressures of at least 5,000 mbar, and the carbon dioxide-adsorbent material is a porous metal-organic framework material;

a heater for heating the carbon dioxide-adsorbent material in the first chamber, wherein the heater is able to heat the carbon dioxide adsorbent material to a second temperature, wherein the second temperature is at least 60° C.;

a two-port input valve in fluid communication with the gas inlet of the first chamber for connection of the gas inlet of the first chamber to a source of compressed dry air; a two-port first output valve in fluid communication with the gas outlet of the first chamber for connection of the gas outlet of the first chamber to a reduced-carbon dioxide compressed dry air output;

a two-port second output valve in fluid communication with the gas outlet of the first chamber for connection of the gas outlet of the first chamber to the carbon dioxide output;

a two-port vent valve for venting the first chamber to the atmosphere, wherein the vent valve is in fluid communication with the gas outlet of the first chamber;

a second chamber comprising a carbon dioxide-adsorbent material, a gas inlet, and a gas outlet, wherein the second chamber is a pressurisable chamber able to withstand pressures of at least 5,000 mbar, and the carbon dioxide-adsorbent material is a porous metal-organic framework material;

a heater for heating the carbon dioxide-adsorbent material in the second chamber, wherein the heater is able to heat the carbon dioxide adsorbent material to a second temperature, wherein the second temperature is at least 60° C.;

a two-port input valve in fluid communication with the gas inlet of the second chamber for connection of the gas inlet of the second chamber to a source of compressed dry air;

a two-port first output valve in fluid communication with the gas outlet of the second chamber for connection of the gas outlet of the second chamber to a reduced-carbon dioxide compressed dry air output;

a two-port second output valve in fluid communication with the gas outlet of the second chamber for connection of the gas outlet of the second chamber to the carbon dioxide output;

a two-port vent valve for venting the second chamber to the atmosphere, wherein the vent valve is in fluid communication with the gas outlet of the second chamber;

a vacuum pump for reducing the pressure in the first chamber and the second chamber and/or for drawing gas from the first chamber and the second chamber, wherein the vacuum pump is in fluid communication with the second output valve of the first chamber and the second output valve of the second chamber, and the vacuum pump is able to reduce the pressure in the first chamber and the second chamber to less than 10 mbar; and

a three-port vacuum pump valve in fluid communication with the vacuum pump, the atmosphere, and the carbon dioxide output.

According to a third aspect of the present invention, there is provided a compressed dry air production system comprising:
a source of compressed dry air;
a carbon dioxide capture unit;
a reduced-carbon dioxide compressed dry air output; and
a carbon dioxide output;
wherein the carbon dioxide capture unit comprises:
at least one chamber comprising a carbon dioxide-adsorbent material, a gas inlet, and a gas outlet,
a heater for heating the carbon dioxide-adsorbent material,
an input valve in fluid communication with the gas inlet and the source of compressed dry air, and
at least one output valve in fluid communication with the gas outlet, the reduced-carbon dioxide output, and the carbon dioxide output.

The suitable features and advantages of the source of compressed dry air, the carbon dioxide output and the carbon dioxide capture unit of this third aspect are as described above in relation to the first and second aspects.

The source of compressed dry air suitably comprises an air input. The air input suitably provides air, for example ambient air obtained from the immediate surroundings. The air provided by the air input suitably contains water vapour.

The source of compressed dry air suitably comprises a compressor. The compressor is suitably able to compress air to a required pressure, thereby producing compressed air. Suitably the required pressure is greater than 1,000 mbar, suitably significantly greater than 1,000 bar. Suitably the required pressure is at least 2,000 mbar, for example at least 5,000 mbar, suitably at least 9,000 mbar. Suitably the required pressure is up to 20,000 mbar, for example up to 15,000 mbar, suitably up to 11,000 mbar. Suitably the required pressure is from 2,000 to 20,000 mbar, for example from 5,000 to 15,000 mbar, suitably from 9,000 to 11,000 mbar.

The source of compressed dry air suitably comprises a buffer tank. The buffer tank may act as a store for compressed air. Suitably the buffer tank removes water from compressed air, thereby producing partially dry compressed air. Suitably the buffer tank produces liquid water from compressed air, for example by condensation. The buffer tank suitably comprises a means for removing liquid water from the buffer tank, for example a draining device.

The source of compressed dry air suitably comprises one or more filters. The one or more filters suitably remove contaminants from partially dry compressed air, thereby producing filtered partially dry compressed air. The contaminants may include dust, oil, and microorganisms. The one or more filters may comprise more than one filter or only one filter. The one or more filters may comprise one or more filters per type of contaminant.

The source of compressed dry air suitably comprises an air dryer. The air dryer suitably decreases the water content of filtered partially dry compressed air, thereby producing compressed dry air. Suitably the air dryer comprises a refrigerated dryer, a membrane dryer, a desiccant dryer, or a combination thereof.

A refrigerated dryer suitably comprises a refrigerant for cooling filtered partially dry compressed air and causing water vapour in the filtered partially dry compressed air to condense into liquid water, which may be removed from the dryer. A membrane dryer suitably comprises a membrane with a high affinity for water vapour. A desiccant dryer suitably comprises a desiccant which is able to adsorb water vapour.

The source of compressed dry air suitably comprises a compressor, a buffer tank, one or more filters, and an air dryer as defined above.

The source of compressed dry air suitably comprises one or more sensors for determining the pressure, temperature, humidity, and/or carbon dioxide content of the compressed dry air. The source of compressed dry air may comprise a pressure sensor, a temperature sensor, a humidity sensor, a carbon dioxide sensor, or a combination thereof.

Suitably the source of compressed dry air provides compressed dry air having a pressure dew point of less than 10° C., for example less than 0° C., suitably less than −10° C. Suitably the source of compressed dry air provides compressed dry air having a pressure dew point of at least −90° C., for example at least −80° C., suitably at least −70° C. Suitably the source of compressed dry air provides compressed dry air having a pressure dew point of from −90 to 10° C., for example from −80 to 0° C., suitably from −70 to −10° C.

The reduced-carbon dioxide compressed dry air output suitably comprises one or more filters. Suitably the reduced-carbon dioxide compressed dry air output comprises one or more particle filters for removing solid particles from the compressed dry air.

The reduced-carbon dioxide compressed dry air output suitably comprises an outlet for dispensing reduced-carbon dioxide compressed dry air. Any outlet suitable for dispensing compressed dry air may be used. For example, the outlet may be a nozzle.

The reduced-carbon dioxide compressed dry air output may comprise a compressed gas storage tank. Such storage tank may be detachable from the compressed dry air production system.

The reduced-carbon dioxide compressed dry air output may be connected to any suitable device for which compressed dry air is normally used. Such devices would be known to the skilled person. The reduced-carbon dioxide compressed dry air output may be connected to a spraying device, a device for operating air controlled tools, a cooling device, a handling device, a cleaning device, a pneumatic device, a refrigeration device, a sandblasting device, an injection moulding device, or a device for the packaging of foods and beverages.

The compressed dry air production system may comprise a bypass. The bypass suitably allows compressed dry air to pass from the source of compressed dry air to the reduced-carbon dioxide compressed dry air output without passing through the carbon dioxide capture unit. This advantageously allows the production of compressed dry air in the system even if maintenance is performed on the carbon dioxide capture unit, and also allows the carbon dioxide-adsorbent material to be protected if the conditions (e.g., pressure, temperature, humidity, level of carbon dioxide) of the compressed dry air are not within the suitable operational ranges.

The compressed dry air production system may comprise a bypass input valve in fluid communication with the source of compressed dry air, the carbon dioxide capture unit and the bypass, and a bypass output valve in fluid communication with the reduced-carbon dioxide compressed dry air output, the carbon dioxide capture unit, and the bypass. The bypass input valve may be a three-port valve. The bypass output valve may be a three-port valve. The bypass input valve and the bypass output valve may have a first position which allows gas to pass from the source of compressed dry air to the reduced-carbon dioxide compressed dry air output through the carbon dioxide capture unit without passing through the bypass, and a second position which allows gas to pass from the source of compressed dry air to the reduced-carbon dioxide compressed dry air output through the bypass without passing through the carbon dioxide capture unit.

Alternatively, the compressed dry air production system may comprise a bypass input valve in fluid communication with the source of compressed dry air, the carbon dioxide capture unit, and a compressed dry air output. The suitable features of the compressed dry air output are as described above in relation to the reduced-carbon dioxide compressed dry air output.

In some embodiments the system according to the third aspect comprises:
a source of compressed dry air comprising an air input, a compressor able to compress air to a pressure of greater than 1,000 mbar, a buffer tank, one or more filters, and an air dryer, wherein the source of compressed dry air provides compressed dry air having a pressure dew point of less than 10° C.;
a carbon dioxide capture unit;
a reduced-carbon dioxide compressed dry air output comprising one or more filters and an outlet for dispensing reduced-carbon dioxide compressed dry air; and
a carbon dioxide output comprising a carbon dioxide storage vessel able to store carbon dioxide under a pressure of higher than 1,000 mbar;
wherein the carbon dioxide capture unit comprises:

at least one chamber comprising a carbon dioxide-adsorbent material, a gas inlet, and a gas outlet, wherein the at least one chamber is a pressurisable chamber able to withstand pressures of greater than 1,000 mbar, and the carbon dioxide-adsorbent material is a porous material which preferentially adsorbs carbon dioxide over other gases present in compressed dry air;

a heater for heating the carbon dioxide-adsorbent material, wherein the heater is able to heat the carbon dioxide adsorbent material to a second temperature, wherein the second temperature is at least 50° C.;

a two-port input valve in fluid communication with the gas inlet and the source of compressed dry air;

a two-port first output valve in fluid communication with the gas outlet and the reduced-carbon dioxide compressed dry air output;

a two-port second output valve in fluid communication with the gas outlet and the carbon dioxide output;

a two-port vent valve for venting the at least one chamber to the atmosphere, wherein the vent valve is in fluid communication with the gas outlet of the at least one chamber;

a vacuum pump for reducing the pressure in the at least one chamber and/or for drawing gas from the at least one chamber, wherein the vacuum pump is in fluid communication with the second output valve, and the vacuum pump is able to reduce the pressure in the at least one chamber to less than 20 mbar; and

a three-port vacuum pump valve in fluid communication with the vacuum pump, the atmosphere, and the carbon dioxide output.

In some embodiments the system according to the third aspect comprises:
a source of compressed dry air comprising an air input, a compressor able to compress air to a pressure of at least 5,000 mbar, a buffer tank, one or more filters, and an air dryer, wherein the source of compressed dry air provides compressed dry air having a pressure dew point of less than 0° C.;
a carbon dioxide capture unit;
a reduced-carbon dioxide compressed dry air output comprising one or more filters and an outlet for dispensing reduced-carbon dioxide compressed dry air;
a carbon dioxide output comprising a carbon dioxide compressor and a carbon dioxide storage vessel able to store carbon dioxide under a pressure of higher than 1,000 mbar;
a bypass for allowing compressed dry air to pass from the source of compressed dry air to the reduced-carbon dioxide compressed dry air output without passing through the carbon dioxide capture unit;
a three-port bypass input valve in fluid communication with the source of compressed dry air, the carbon dioxide capture unit and the bypass; and
a three-port bypass output valve in fluid communication with the reduced-carbon dioxide compressed dry air output, the carbon dioxide capture unit and the bypass;
wherein the carbon dioxide capture unit comprises:

a first chamber comprising a carbon dioxide-adsorbent material, a gas inlet, and a gas outlet, wherein the first chamber is a pressurisable chamber able to withstand pressures of at least 5,000 mbar, and the carbon dioxide-adsorbent material is a porous metal-organic framework material;

a heater for heating the carbon dioxide-adsorbent material in the first chamber, wherein the heater is able to heat the carbon dioxide adsorbent material to a second temperature, wherein the second temperature is at least 60° C.;

a two-port input valve in fluid communication with the gas inlet of the first chamber and the source of compressed dry air;

a two-port first output valve in fluid communication with the gas outlet of the first chamber and the reduced-carbon dioxide compressed dry air output;

a two-port second output valve in fluid communication with the gas outlet of the first chamber and the carbon dioxide output;

a two-port vent valve for venting the first chamber to the atmosphere, wherein the vent valve is in fluid communication with the gas outlet of the first chamber;

a second chamber comprising a carbon dioxide-adsorbent material, a gas inlet, and a gas outlet, wherein the second chamber is a pressurisable chamber able to withstand pressures of at least 5,000 mbar, and the carbon dioxide-adsorbent material is a porous metal-organic framework material;

a heater for heating the carbon dioxide-adsorbent material in the second chamber, wherein the heater is able to heat the carbon dioxide adsorbent material to a second temperature, wherein the second temperature is at least 60° C.;

a two-port input valve in fluid communication with the gas inlet of the second chamber and the source of compressed dry air;

a two-port first output valve in fluid communication with the gas outlet of the second chamber and the reduced-carbon dioxide compressed dry air output;

a two-port second output valve in fluid communication with the gas outlet of the second chamber and the carbon dioxide output;

a two-port vent valve for venting the second chamber to the atmosphere, wherein the vent valve is in fluid communication with the gas outlet of the second chamber;

a vacuum pump for reducing the pressure in the first chamber and the second chamber and/or for drawing gas from the first chamber and the second chamber, wherein the vacuum pump is in fluid communication with the second output valve of the first chamber and the second output valve of the second chamber, and the vacuum pump is able to reduce the pressure in the first chamber and the second chamber to less than 10 mbar; and

a three-port vacuum pump valve in fluid communication with the vacuum pump, the atmosphere, and the carbon dioxide output.

According to a fourth aspect of the present invention, there is provided a use of a carbon dioxide-adsorbent material for separating compressed dry air to provide carbon dioxide and reduced-carbon dioxide compressed dry air.

The carbon dioxide-adsorbent material is suitably comprised in a carbon dioxide capture unit, suitably according to the second aspect.

The carbon dioxide capture unit may be comprised in a compressed dry air production system, suitably according to the third aspect.

The suitable features and advantages of the carbon dioxide adsorbent material, carbon dioxide capture unit, compressed dry air production system, and reduced-carbon dioxide compressed dry air are as described above in relation to the first, second, and third aspects.

### BRIEF DESCRIPTION OF THE DRAWINGS

For a better understanding of the invention, and to show how example embodiments may be carried into effect, reference will now be made to the accompanying drawings in which:

FIG. 1 is a diagram of a compressed dry air production system according to the third aspect of the present invention.

FIG. 2 is a graph showing the evolution of the pressure and temperature in a first chamber during a method according to the first aspect of the present invention.

### DETAILED DESCRIPTION OF THE EXAMPLE EMBODIMENTS

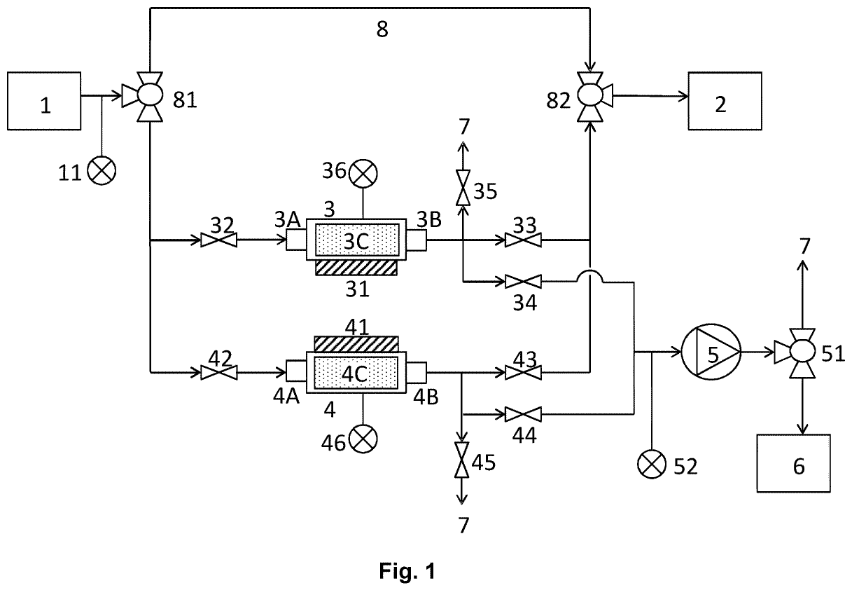

FIG. 1 shows a compressed dry air production system according to the third aspect of the present invention comprising a source of compressed dry air (1), a reduced-carbon dioxide compressed dry air output (2), and a carbon dioxide capture unit. The carbon dioxide capture unit comprises a first chamber (3) comprising a gas inlet (3A), a gas outlet (3B), and a carbon dioxide-adsorbent material (3C), a heater (31) for heating the carbon dioxide-adsorbent material (3C), a carbon dioxide output (6), an input valve (32) in fluid communication with the gas inlet (3A) and the source of compressed dry air (1), an output valve (33) in fluid communication with the gas outlet (3B) and the reduced-carbon dioxide compressed dry air output (2), an output valve (34) in fluid communication with the gas outlet (3B) and the carbon dioxide output (6), and a vent valve (35) in fluid communication with the gas outlet (3B). The carbon dioxide capture unit also comprises a second chamber (4) comprising a gas inlet (4A), a gas outlet (4B), and a carbon dioxide-adsorbent material (4C), a heater (41) for heating the carbon dioxide-adsorbent material (4C), an input valve (42) in fluid communication with the gas inlet (4A) and the source of compressed dry air (1), an output valve (43) in fluid communication with the gas outlet (4B) and the reduced-carbon dioxide compressed dry air output (2), an output valve (44) in fluid communication with the gas outlet (4B) and the carbon dioxide output (6), and a vent valve (45) in fluid communication with the gas outlet (4B). The system also comprises a bypass conduit (8) which allows compressed dry air from the source of compressed dry air (1) to flow to the output (2) without passing through the carbon capture unit. The bypass conduit comprises bypass input valve (81) which is a three-port valve in fluid communication with the source of compressed dry air (1), the bypass (8), and the input valves (32, 42), and a bypass output valve (82) which is a three-port valve in fluid communication with the bypass (8), the reduced-carbon dioxide compressed dry air output (2), and the output valves (33, 43). In this example the first chamber (3) and the second chamber (4) each contain 137 kg of SIFSIX-3-Ni as the carbon dioxide-adsorbent material (3C) and (4C).

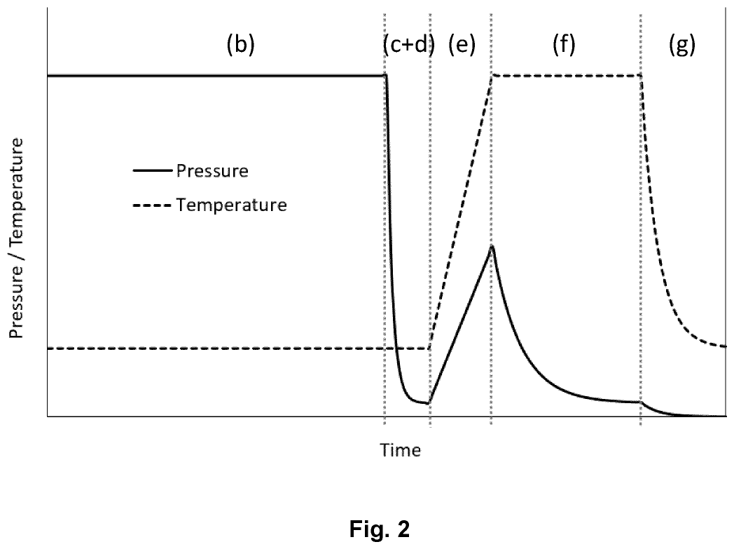

The system in FIG. 1 may be used to carry out a method according to the first aspect of the present invention. Arrows in FIG. 1 indicated the direction of gas flow. FIG. 2 shows the evolution of the pressure and temperature in the first chamber (3) during a complete cycle of steps (b) to (g) in a method according to the first aspect of the present invention.

In step (a) compressed dry air is provided by the source of compressed dry air (1). The bypass input valve (81) is operated to allow compressed dry air to flow from the source of compressed dry air (1) to the input valve (32) of the first chamber (3) and the input valve (42) of the second chamber (4). The pressure, temperature, humidity, and carbon dioxide level of the compressed dry air are controlled with the help of sensors (11).

The following list highlights the key parameters of a common compressed dry air (CDA) production unit which may be used as a source of compressed dry air: flow: 1500 Nm³/h, pressure: 10 bar, temperature: 20° C., pressure dew point: −40° C., carbon dioxide concentration: 400 ppm.

In step (b) the input valve (32) and the output valve (33) are open and allow compressed dry air to flow through the gas inlet (3A) into the first chamber (3). The temperature of the carbon dioxide-adsorbent material (3C) is held at a first temperature, for example 20° C. The pressure in the first chamber (3) is for example 10,000 mbar. The temperature of the carbon dioxide-adsorbent material (3C) and the pressure in the first chamber (3) are controlled with the help of sensors (36). Carbon dioxide is captured from the compressed dry air and reduced-carbon dioxide compressed dry air flows out of the first chamber (3), through the gas outlet (3B), the output valve (33), and the bypass output valve (82) to the reduced-carbon dioxide compressed dry air output (2). The output valve (34) and the vent valve (35) are closed to isolate the first chamber (3) from the atmosphere (7) and a vacuum pump (5). Step (b) is completed when the carbon dioxide-adsorbent material (3C) is saturated with carbon dioxide, for example after 8 hours.

In step (c) the input valve (32) and the output valve (33) are closed in order to close the first chamber (3) to the source of compressed dry air (1). At this stage the carbon dioxide-adsorbent material (3C) is saturated with carbon dioxide, but the gas phase in the first chamber (3) still contains residual air. In order to provide high purity carbon dioxide when the adsorbed carbon dioxide is recovered, residual air is first removed by opening the vent valve (35) to the atmosphere (7), allowing the pressure in the first chamber (3) to decrease to atmospheric pressure, for example 1,000 mbar.

In step (d) the vent valve (35) is closed and the output valve (34) is opened. The vacuum pump (5), which is for example a dry pump, reduces the pressure in the first chamber (3) to the partial pressure of the carbon dioxide, for example to 4 mbar, and the remaining dry air in the first chamber (3) flows through the output valve (34), the vacuum pump (5) and the vacuum pump valve (51) to be released to the atmosphere (7). A pressure sensor (52) is used to determine the pressure in the vacuum pump (5).

The temperature of the carbon dioxide-adsorbent material (3C) in steps (c) and (d) is the first temperature, for example 20° C. The combined duration of steps (c) and (d) is for example 90 seconds.

In step (e) the first chamber (3) is sealed by closing the output valve (34) when the pressure in the first chamber (3) is sufficiently low, for example 4 mbar. The saturated carbon dioxide-adsorbent material (3C) is heated to a second temperature, for example to 80° C., using the heater (31) in order to release carbon dioxide from the material (3C). This increases the carbon dioxide pressure in the first chamber (3), for example to 150 mbar. Increasing the temperature of the saturated carbon dioxide-adsorbent material (3C) may increase the equilibrium pressure of the carbon dioxide because adsorption is an exothermic phenomenon. The heating may be achieved using waste operational heat associated with the compressor unit of the source of compressed dry air (1), green energy or carbon-emitting energy. The duration of step (e) is for example 1 hour.

In step (f) the first chamber (3) is connected to the vacuum pump (5) by opening the outlet valve (34) while the carbon dioxide-adsorbent material (3C) is maintained at the second temperature, for example 80° C. The position of the vacuum pump valve (51), which is a three-port valve, is set such that carbon dioxide flows from the first chamber (3) to the carbon dioxide output (6) through the output valve (34) and the vacuum pump (5). The percentage of recovered carbon dioxide is selected to ensure economical capture, as an ideal 100% recovery of the carbon dioxide will result in unfavourably increased costs. For example step (f) is completed once 80% carbon dioxide recovery is reached after 4 hours, during which the pressure in the first chamber (3) decreases to 9.2 mbar.

Step (g): When the carbon dioxide release is completed, the first chamber (3) is sealed by closing the output valve (34). The carbon dioxide-adsorbent material (30) is cooled to the first temperature, for example 20° C. This is achieved passively (using the heat loss) or actively using a cooling system (not shown). Step (g) for example lasts for 3 hours, during which time the pressure in the first chamber (3) decreases to 0.24 mbar due to the modification of the adsorption equilibrium. Once step (g) is completed a new capture cycle may be commenced starting with step (b).

The operating conditions of the above method are summarised in Table 1.

TABLE 1
Example operating conditions of the carbon dioxide capture method.

| | | Temperature | Pressure | | |
|---|---|---|---|---|---|
| Steps | | (° C.) | (mbar) | Duration | |
| Step (b): Carbon dioxide capture | | 20 | 10 000 | 8 | h |
| Carbon | Steps (c) and (d): | 20 | 10 000 → 4 | 1.5 | min |
| dioxide | Evacuation of residual air | | | | |
| release | Step (e): Closed system | 20 → 80 | 4 → 150 | 1 | h |
| | heating | | | | |
| | Step (f): Carbon dioxide | 80 | 150 → 9.2 | 4 | h |
| | release | | | | |
| | Step (g): Cooling | 80 → 20 | 9.2 → 0.24 | 3 | h |

Step (b), step (c), step (d), step (e), step (D) and step (g) are carried out in the second chamber (4) in the same way as in the first chamber (3), except that the gas inlet (4A), gas outlet (4B3), carbon dioxide-adsorbent material (4C), heater (41), input valve (42), output valves (43, 44), vent valve (45), and sensors (46) are used instead of the gas inlet (3A), gas outlet (3B3), carbon dioxide-adsorbent material (3C), heater (31), input valve (32), output valves (33, 34), vent valve (35), and sensors (36).

The system is designed in such a way that the time periods of the capture and the release steps are substantially equal. This enables the first chamber (3) to capture carbon dioxide while the second chamber (4) releases carbon dioxide and undergoes regeneration, and vice versa.

For example, step (b) is carried out in the first chamber (3) while step (c), step (d), step (e), step (f, and step (g) are carried out in the second chamber (4), and step (b) is carried out in the second chamber (4) while step (c), step (d), step (e), step (f, and step (g) are carried out in the first chamber (3).

The relative timing and order of the steps is presented in Table 2.

TABLE 2
Steps of the method used by the carbon dioxide capture unit

| First chamber (3) | Step (b): carbon dioxide | | | | Carbon dioxide release | | | |
|---|---|---|---|---|---|---|---|---|
| | capture | | | | steps | | | |
| | | | | | (c + d) | (e) | (f) | (g) |
| Second chamber | Carbon dioxide release | | | | Step (b): carbon dioxide | | | |
| (4) | steps | | | | capture | | | |
| | (c + d) | (e) | (f) | (g) | | | | |

The beginning of step (b) involving the first chamber (3) coincides with the beginning of step (c) involving the second chamber (4). The end of step (g) involving the second chamber (4) coincides with the end of step (b) involving the first chamber (3), whereby the carbon dioxide-adsorbent material (3C) is saturated with carbon dioxide. Then, the input valve (32) and the output valve (33) are closed and the first chamber (3) undergoes the carbon dioxide release process. At the same time, the input valve (42) and the output valve (43) are opened and the second chamber (4) begins capturing carbon dioxide from the compressed dry air, coinciding with the beginning of step (b) involving the second chamber (4).

The cost and energy required to capture carbon dioxide from air have up to now prevented widespread commercialisation of direct air capture technologies. These problems may be addressed by the example embodiments as described herein, which provide low cost and low energy methods for capturing carbon dioxide from air.

In summary a method is disclosed for separating compressed dry air to provide carbon dioxide and reduced-carbon dioxide compressed dry air. The method comprises providing a source of compressed dry air and admitting compressed dry air into a first chamber containing a carbon dioxide-adsorbent material at a first temperature. The carbon dioxide-adsorbent material adsorbs carbon dioxide from the compressed dry air to form reduced-carbon dioxide compressed dry air, which is allowed to pass out of the first chamber. The first chamber is closed to the source of compressed dry air. Then the carbon dioxide-adsorbent material is heated to a second temperature. This releases carbon dioxide from the carbon dioxide-adsorbent material, which carbon dioxide is removed from the first chamber. The method is low cost and low energy, and can easily be integrated into existing compressed dry air systems. A carbon dioxide capture unit, a compressed dry air production system, and a use of a first chamber containing a carbon dioxide-adsorbent material for separating compressed dry air to provide carbon dioxide and reduced-carbon dioxide compressed dry air are also described.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of separating compressed dry air to provide carbon dioxide and reduced-carbon dioxide compressed dry air, the method comprising the steps of:
a) providing a source of compressed dry air;
b) admitting compressed dry air into a first chamber containing a carbon dioxide-adsorbent material at a first temperature in order to adsorb carbon dioxide from the compressed dry air onto the carbon dioxide-adsorbent material and to form reduced-carbon dioxide compressed dry air, and allowing the reduced-carbon dioxide compressed dry air to pass out of the first chamber;
c) closing the first chamber to the source of compressed dry air;
e) heating the carbon dioxide-adsorbent material to a second temperature in order to release carbon dioxide from the carbon dioxide-adsorbent material; and
f) removing the carbon dioxide from the first chamber.

2. The method of claim 1, further comprising, after step c) and before step e), the step of:
d) evacuating the first chamber to remove residual dry air from the first chamber.

3. The method of claim 1, wherein step (b) is carried out until the carbon dioxide-adsorbent material is at least 70% saturated with carbon dioxide.

4. The method of claim 1, wherein step (d) and/or step (f) comprises applying a vacuum to the first chamber.

5. The method of claim 1, wherein step (e) comprises sealing the first chamber such that heating the carbon dioxide-adsorbent material to the second temperature increases the pressure of carbon dioxide in the first chamber.

6. The method of claim 5, wherein no other gas contacts the carbon dioxide-adsorbent material in step (e) or step (f.

7. The method of claim 1, wherein the first temperature is ambient and the second temperature is from 50 to 200° C.

8. The method of claim 1, wherein step (f) comprises directing the carbon dioxide removed from the first chamber to a storage vessel.

9. The method of claim 1, further comprising the step of:
g) cooling the carbon dioxide-adsorbent material to the first temperature.

10. The method of claim 9, further comprising repeating step (b) following step (g).

11. The method of claim 1, wherein step (b) is carried out for the same period of time as step (c), step (d), step (e), and step (f), and step (g) when present, combined.

12. The method of claim 1, wherein the pressure in the first chamber in at least a part of step (b) is from 1,000 to 20,000 mbar, and the pressure in the first chamber in at least a part of step (d) when present, step (e), and step (f), and step (g) when present, is less than 10 mbar.

13. The method of claim 1, wherein step (b) is carried out in the first chamber while step (c), step (d) when present, step (e), or step (f), or step (g) when present, is carried out simultaneously in a second chamber containing a carbon dioxide-adsorbent material.

14. A carbon dioxide capture unit for removing carbon dioxide from a source of compressed dry air, the carbon dioxide capture unit comprising:
at least one chamber comprising a carbon dioxide-adsorbent material, a gas inlet, and a gas outlet;
a heater for heating the carbon dioxide-adsorbent material;
an input valve in fluid communication with the gas inlet for connection of the gas inlet to a source of compressed dry air; and
at least one output valve in fluid communication with the gas outlet for connection of the gas outlet to a reduced-carbon dioxide compressed dry air output and a carbon dioxide output.

15. A compressed dry air production system comprising:
a source of compressed dry air;
a carbon dioxide capture unit;
a reduced-carbon dioxide compressed dry air output; and
a carbon dioxide output;
wherein the carbon dioxide capture unit comprises:
at least one chamber comprising a carbon dioxide-adsorbent material, a gas inlet, and a gas outlet,
a heater for heating the carbon dioxide-adsorbent material,
an input valve in fluid communication with the gas inlet and the source of compressed dry air, and
at least one output valve in fluid communication with the gas outlet, the reduced-carbon dioxide compressed dry air output, and the carbon dioxide output.

16. The carbon dioxide capture unit of claim 14, wherein the at least one chamber comprises a first chamber and a second chamber which are not in fluid communication with the same input valve.

17. The system of claim 15, wherein the at least one chamber comprises a first chamber and a second chamber which are not in fluid communication with the same input valve.
